(19) United States
(12) Patent Application Publication
(10) Pub. No.: US 2012/0217248 A1
(43) Pub. Date: Aug. 30, 2012

(54) ORGANIZATION DEVICE AND MANUFACTURING METHOD OF THE SAME

(76) Inventor: Chen-Jui MA, Taipei City (TW)

(21) Appl. No.: 13/091,428

(22) Filed: Apr. 21, 2011

(30) Foreign Application Priority Data
Feb. 25, 2011 (TW) 100106491

(51) Int. Cl. B65D 25/04; B32B 38/10; B32B 37/02; B32B 37/16; B65D 85/18; B65D 33/14

(52) U.S. Cl. 220/500; 206/278; 383/6; 156/73.1

(57) ABSTRACT

An organization device and manufacturing method of the same are revealed. The organization device is formed by a plurality pieces of cloth joined with one another. The weld zones, peripheries and folded areas of the pieces of cloth are joined by ultrasonic welding so as to form a receiving space among the pieces of cloth. At the same time, the weld zones treated by ultrasonic welding are flat so that the organization device is easy to be folded and packaged. At the same time, the organization device doesn't need binding so that the manufacturing processes are simplified, the production efficiency is improved, the labor is saved and the cost is reduced. Moreover, the aesthetic and decorative values of the organization device are improved.

### BACKGROUND OF THE INVENTION

The present invention relates to an organization device and a manufacturing method of the same, especially to an organization device produced by ultrasonic welding technique with simplified manufacturing processes, higher efficiency, low cost and improved aesthetic appearance.

Organization devices such as organization boxes, garment bags, clothes presses, underbed storage units, eye level cabinets, or shoe cabinets with multiple compartments, closets with multiple compartments, hanging bags with multiple pockets, wire bins etc are our daily essentials. They are used for convenient storage and object classification. Moreover, they can be moved easily to the desired positions.

Generally, organization devices are arranged with openings for taking things out or putting things in. The opening is disposed with other components such as covers or zippers. Moreover, an inner space of the organization device can be divided into several compartments and a hole is arranged at a top end of the organization device so that the device is used together with hooks. Or the organization device is disposed with Velcro tapes so as to be hung on a rod provided.

The organization devices available now are made from flexible fiber fabric or plastic cloth with certain strength. A plurality of pieces of cloth is connected with one another by sewing to form an integrated device. And the sewed area is applied with binding. Take an eye level cabinet as an example. For easy processing, the two side walls are made from soft material and connected with a back wall by sewing. And a plurality of plates are arranged horizontally at certain intervals and sewed between two side walls. Then the sewed area is treated by binding. Thus a plurality of compartments for storage and management is formed. The eye level cabinet is made from soft fabric so that it can be folded into a small volume for storage while not in use. However, the binding has negative effect on the flatness of the folded cabinet, not only the appearance but also the reduced volume. Moreover, the binding is with fixed pattern, unable to be processed to have other patterns. The aesthetic and decorative values of the cabinet are restricted.

In order to solve above shortcomings, there is a need to provide a novel organization device and a manufacturing method of the same with no additional binding, simple manufacturing processes, higher production efficiency, reduced labor and lower cost.

### SUMMARY OF THE INVENTION

Therefore it is a primary object of the present invention to provide an organization device and a manufacturing method of the same in which a plurality pieces of cloth is joined by ultrasonic welding so that there is no binding needed. Thus the manufacturing processes are simplified, the production efficiency is improved, and the cost is reduced. Moreover, the organization device with better flatness is easy to be folded and packaged. At the same time, the aesthetic and decorative values of the organization device are improved.

In order to achieve the above object, an organization device of the present invention includes at least one first piece of cloth and at least one second piece of cloth. The first piece of cloth having at least one weld zone is cut into shape and size required in advance. The second piece of cloth is made from the same material as that of the first piece of cloth, cut into shape and size required in advance and having at least one weld zone corresponding to the weld zone of the first piece of cloth. The weld zone of the first piece of cloth and the weld zone of the second piece of cloth are connected by ultrasonic welding and at least one receiving space between the first piece of cloth and the second piece of cloth is formed. Thus the organization device is produced.

A manufacturing method of the organization device according to the present invention includes a plurality of steps. Firstly provide at least one piece of first cloth that is cut into required shape and size according to a design of an organization device and having at least one weld zone for being joined with other weld zones by ultrasonic welding. Then provide at least one second piece of cloth that is made from the same material as the first piece of cloth and is cut into required shape and size according to a design of an organization device. The second piece of cloth includes at least one weld zone that is corresponding to the weld zone of the first piece of cloth and is used for being joined with other weld zones by ultrasonic welding. Next use ultrasonic welding to connect the weld zone of the first piece of cloth with the weld zone of the second piece of cloth and produce at least one receiving space between the at least one first piece of cloth and the at least one second piece of cloth for producing an organization device.

Furthermore, the weld zones of the first piece of cloth and the second piece of cloth are flat after being joined by ultrasonic welding so that the organization device is easy to be folded and packaged. In addition, running stitches are formed on surfaces of the weld zones for improvement of aesthetic value. The weld zones can also be processed by lace sewing such as seaming, cutting, stripping, pressing, printing, hot stamping, pleating, or reinforcement so as to increase aesthetic and decorative values.

### BRIEF DESCRIPTION OF THE DRAWINGS

FIG. 1 is a schematic drawing showing an embodiment according to the present invention;

FIG. 2 is a schematic drawing showing another embodiment according to the present invention;

FIG. 2A is a partial enlarged view of a cross section of the embodiment in FIG. 2;

FIG. 3 is a schematic thawing showing a further embodiment according to the present invention;

FIG. 3A is a partial enlarged view of the embodiment in FIG. 3;

FIG. 4 is a schematic drawing showing a further embodiment according to the present invention;

FIG. 5 is a schematic drawing showing a further embodiment according to the present invention;

FIG. 6 is a schematic drawing showing a further embodiment according to the present invention;

FIG. 7 is a schematic drawing showing pattern on weld zones of an embodiment according to the present invention;

FIG. 7A is a schematic drawing showing dotted lines on weld zones of an embodiment according to the present invention.

### DETAILED DESCRIPTION OF THE PREFERRED EMBODIMENT

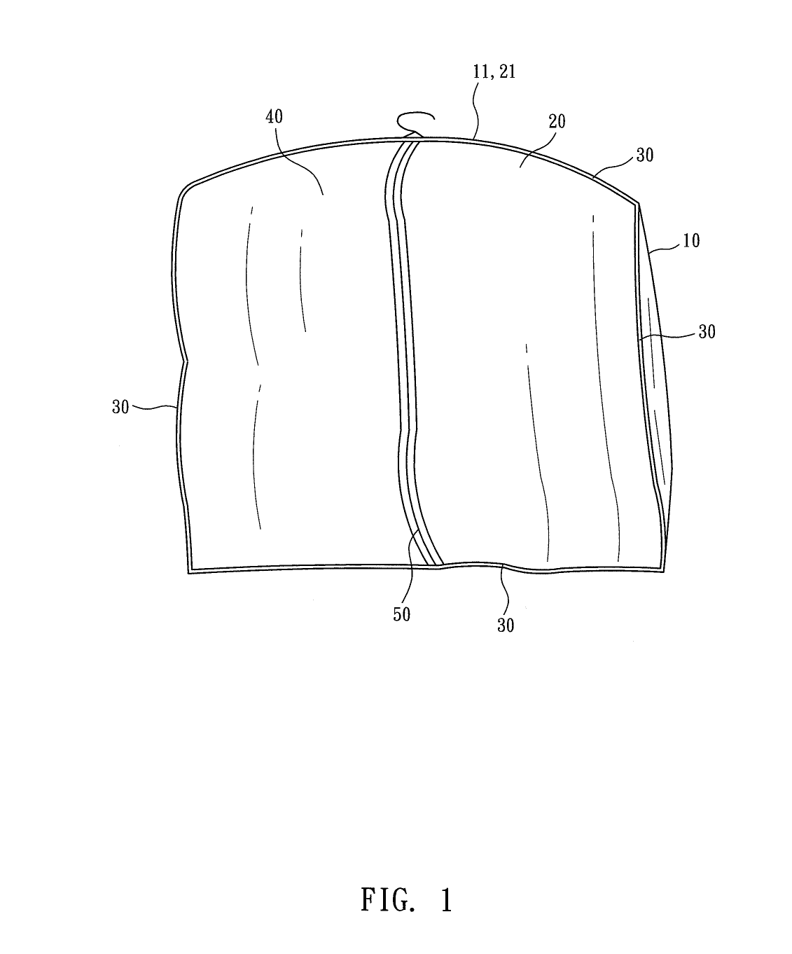

Refer from FIG. 1 to FIG. 6, an organization device of the present invention includes at least one first piece of cloth 10 and at least one second piece of cloth 20, both made from the same materials such as synthetic fiber, blended fabric containing chemical fabric, chemical film or others suitable for ultrasonic welding. The first piece of cloth 10 includes at least one weld zone 101 for being welded by ultrasonic welding. The second piece of cloth 20 also includes at least one weld zone 201 that is corresponding to the weld zone 101 of the first piece of cloth 10 and is used for being welded by ultrasonic welding. The weld zone 101 of the first piece of cloth 10 and the weld zone 201 of the second piece of cloth 20 are welded with each other by the ultrasonic welding process. Both the weld zone 101 and the weld zone 201 look flat and at least one receiving space 40 is formed between the first piece of cloth 10 and the second piece of cloth 20.

A manufacturing method of the organization device according to the present invention includes a plurality of steps. The weld zones 101, 201, peripheries 11, 21 and folded areas 12, 22 of the first piece of cloth 10 and the second piece of cloth 20 are connected to each other correspondingly by ultrasonic welding so as to form at least one receiving space 40 between the first piece of cloth 10 and the second piece of cloth 20. The steps of the manufacturing method are as followings:

Step 1: provide at least one first piece of cloth 10 that is cut into required shape and size in advance according to a design of an organization device; the first piece of cloth 10 having at least one weld zone 101 for being joined with other weld zones by ultrasonic welding;

Step 2: provide at least one second piece of cloth 20 made from the same material as the first piece of cloth 10 and cut into required shape and size in advance according to a design of an organization device; the second piece of cloth 20 also having at least one weld zone 201 corresponding to the weld zone 101 of the first piece of cloth 10 and used for being joined with other weld zones by ultrasonic welding;

Step 3: using ultrasonic welding to connect the weld zone 101 of the first piece of cloth 10 with the weld zone 201 of the second piece of cloth 20 and produce at least one receiving space 40 between the first piece of cloth 10 and the second piece of cloth 20 for producing an organization device.

The weld zone 101 of the first piece of cloth 10 can be disposed on the periphery 11 and the folded area 12 of the first piece of cloth 10. In similar way, the weld zone 201 of the second piece of cloth 20 is arranged at the periphery 21 and the folded area 22 of the second piece of cloth 20. The weld zone 101 and the weld zone 201 can be set on preset positions intended to be joined by ultrasonic welding between the first piece of cloth 10 and the second piece of cloth 20.

In order to meet users' requirements, the organization device has various types. Thereby after being cut into the shape and size required, at least one first piece of cloth 10 and at least one second piece of cloth 20 are folded into preset shape, as shown in the step 1 and step 2. Then the second piece of cloth 20 is put into a preset position on the first piece of cloth 10 correspondingly and the step 3 is run. The at least one first piece of cloth 10 and at least one second piece of cloth 20 are joined with each other by ultrasonic welding to form the organization device with preset styles.

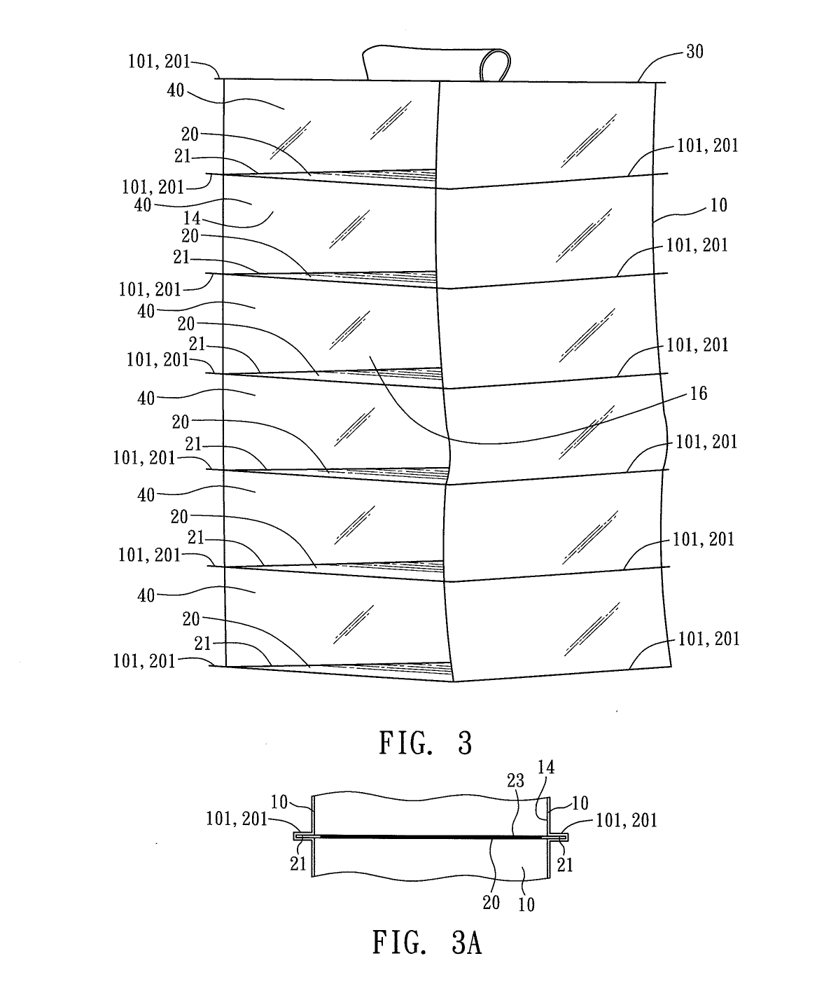

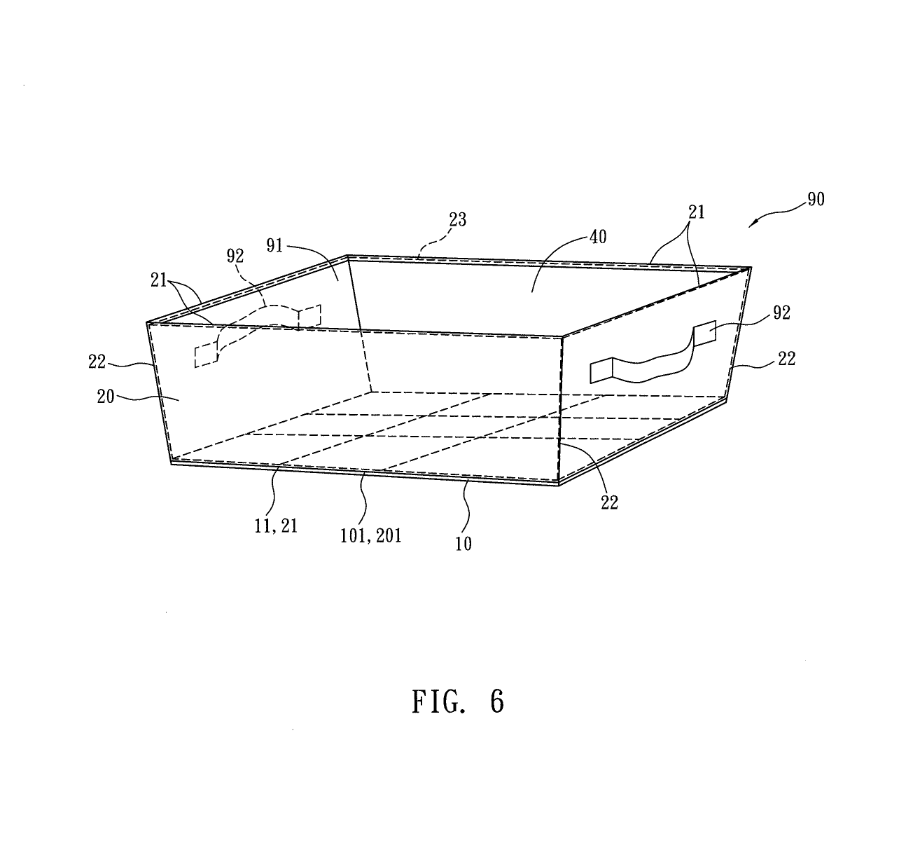

According to the design requirements, the at least one first piece of cloth 10 and at least one second piece of cloth 20 further covers at least one support member 23 for better structural support. The support member 23 can be a support plate shown in FIG. 3A, or a metal wire frame shown in FIG. 6. Such design prevents the deformation of the organization device while being loaded with stuffs and extends service life of the organization device.

The organization device of the present invention can be a garment bag, a hanging bag with multiple pockets, a closet with multiple compartments, an organizer box, a clothes press, an underbed storage unit, an eye level cabinet, a wire bin or a shoe cabinet with multiple compartments.

### Embodiment 1

Refer to FIG. 1, this embodiment is a garment bag. The first piece of cloth 10 and the second piece of cloth 20 are overlapped. The periphery 11 of the first piece of cloth 10 and the periphery 21 of the second piece of cloth 20 are aligned with each other. Then the weld zones 101, 201 on the peripheries 11, 21 are joined together by ultrasonic welding so that the first piece of cloth 10 and the second piece of cloth 20 are connected to each other. The receiving space 40 is formed between the first piece of cloth 10 and the second piece of cloth 20. Moreover, a zipper 50 is arranged at a middle part of the second piece of cloth 20 so as to open or close the receiving space 40.

### Embodiment 2

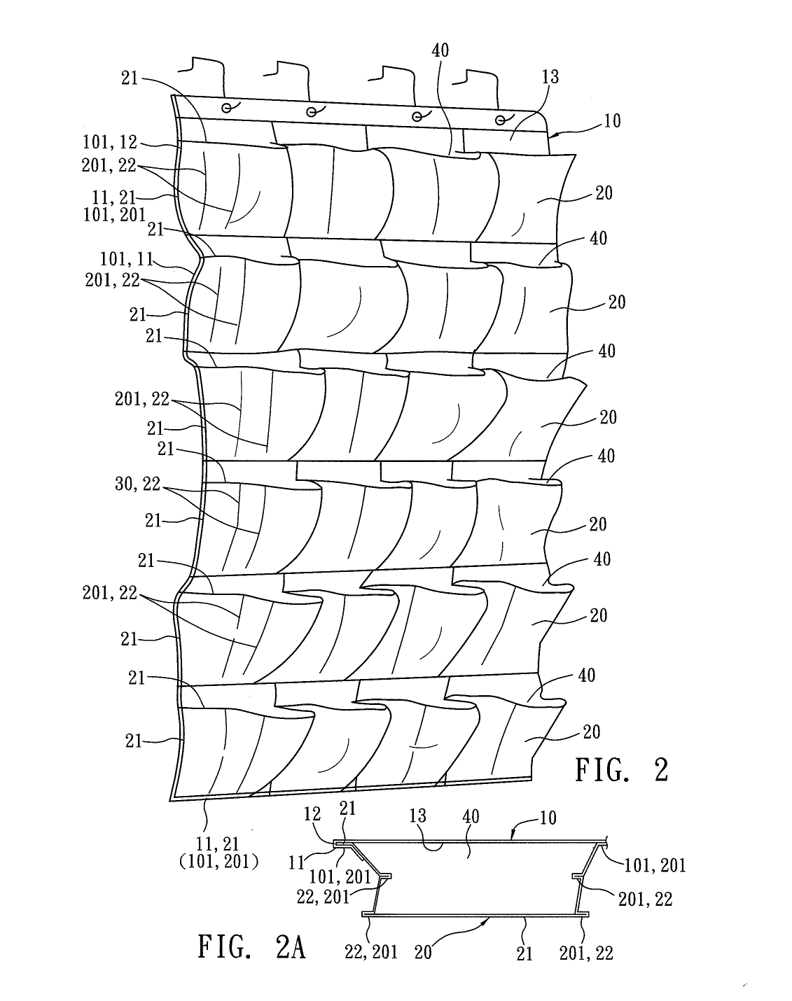

Refer to FIG. 2 and FIG. 2A, this embodiment is a hanging bag with multiple pockets. A plurality of second pieces of cloth 20 is vertically arranged with a certain interval on one side surface 13 of a first piece of cloth 10. The peripheries 11, 21 of the first piece of cloth 10 and the second pieces of cloth 20 are aligned and then weld zones 101, 201 on the peripheries 11, 21 of the first piece of cloth 10 and the second pieces of cloth 20 are joined by ultrasonic welding. Thus the left side, the right side and the bottom side of the second pieces of cloth 20 are welded on the side surface 13 of the first piece of cloth 10. Moreover, certain positions with certain intervals on a front surface of the second pieces of cloth 20 are further treated by an ultrasonic welding process so as to form a plurality of receiving spaces 40 between the first piece of cloth 10 and the second pieces of cloth 20. As shown in FIG. 2, the number of the receiving space 40 produced is 24. This is just an embodiment of the present invention, not limited to this number. Refer to FIG. 2A, the periphery 11 of the first piece of cloth 10 is folded to form a folded area 12 and then the periphery 21 of the second pieces of cloth 20 is clipped inside the folded area 12. Then the ultrasonic welding is performed. Furthermore, a plurality of symmetric folded areas 22 and a plurality of weld zones 201 for ultrasonic welding are formed on the second pieces of cloth 20 so as to increase the structural strength of the receiving space 40, avoid the deformation of the receiving space 40 while being opened and improve the flatness of the receiving space 40 while being folded.

### Embodiment 3

Refer to FIG. 3 and FIG. 3A, this embodiment is a closet with multiple compartments. A first piece of cloth 10 is cut into a preset C-shape whose top and bottom sides are openings with a rectangular space 16 therein. A plurality of rectangular second pieces of cloth 20 is vertically arranged with an interval in the rectangular space 16 of at least one first piece of cloth 10. The left, right and rear sides of the periphery 21 of each second piece of cloth 20 and an inner side surface 14 of the first piece of cloth 10 are treated by an ultrasonic welding process so that weld zones 101, 201 of the first piece of cloth 10 and the second piece of cloth 20 are joined together by ultrasonic welding. A certain amount of receiving spaces 40 are formed among the first piece of cloth 10 and the second pieces of cloth 20. As shown in the FIG. 3, there are six receiving spaces 40 of this embodiment. The number of the receiving space 40 is not limited.

Moreover, the second piece of cloth 20 further encloses at least one support member 23 such as support plate so that the strength of the second piece of cloth 20 is improved. Thus the closet with multiple compartments will not be deformed easily while receiving various objects.

### Embodiment 4

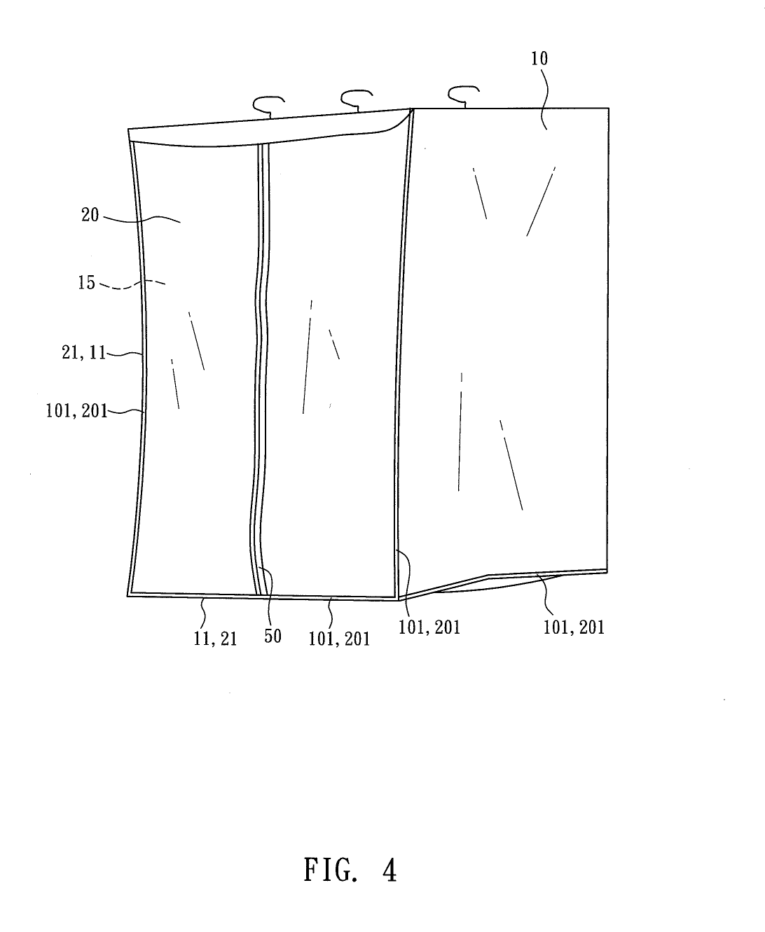

Refer to FIG. 4, this is a clothes press. A plurality of first pieces of cloth 10 is connected to form a rectangular solid with an opening 15. A second piece of cloth 20 is corresponding to the opening 15. Perform an ultrasonic welding process on the periphery 11 of the opening 15 and the periphery 21 of the second piece of cloth 20 so as to join weld zones 101, 201 of the first piece of cloth 10 and the second piece of cloth 20. A receiving space 40 is formed among the second piece of cloth 20 and the first pieces of cloth 10. Moreover, a zipper 50 is arranged at a middle part of the second piece of cloth 20 for opening and closing the receiving space 40.

### Embodiment 5

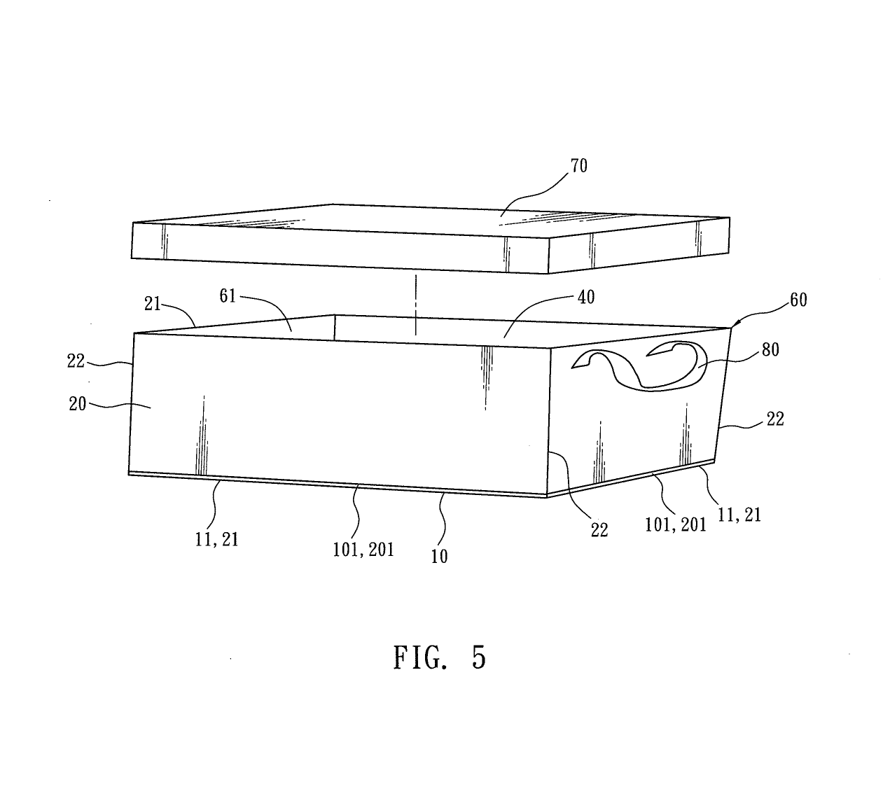

Refer to FIG. 5, a rectangular organizer box 60 is revealed. The shape of the organizer box is not limited to rectangular solid. It can be a cylinder or other shapes. The bottom of the organizer box 60 is formed by a first piece of cloth 10 while lateral sides of the organizer box 60 is formed by a second piece of cloth 20. A periphery 11 of the first piece of cloth 10 and a periphery 21 of the bottom of the second piece of cloth 20 are joined by ultrasonic welding so that weld zones 101, 201 of the first piece of cloth 10 and the second piece of cloth 20 are joined with each other. A receiving space 40 with an opening 61 facing upwards is formed between the second piece of cloth 20 and the first pieces of cloth 10. Moreover, an upper cover 70 for opening and closing the receiving space 40 is disposed over the opening 61 of the organizer box 60. Furthermore, a handle 80 is fixed on an outer side surface of the organizer box 60 by ultrasonic welding.

### Embodiment 6

Refer to FIG. 6, this embodiment is a bin/wire bin. The wire bin is a rectangular basket, but the shape is not limited, can also be round. A bottom surface of the wire bin 90 is formed by a first piece of cloth 10 while side surfaces of the wire bin 90 are formed by a second piece of cloth 20. A periphery 11 on the bottom of the first piece of cloth 10 and a periphery 21 on the bottom of the second piece of cloth 20 are processed by ultrasonic welding so as to join a weld zone 101 of the first piece of cloth 10 and a weld zone 201 of the second piece of cloth 20. A receiving space 40 is formed between the first piece of cloth 10 and the second piece of cloth 20. The receiving space 40 is with an opening 91 facing upward. Moreover, folded areas 22 of the second piece of cloth 20 are applied with ultrasonic welding. A support member 23 such as a metal wire frame is used to support the receiving space 40 for preventing distortion or deformation. Furthermore, after a periphery 21 on the top of the second piece of cloth 20 covering the top end of the support member 23, the periphery 21 on the top of the second piece of cloth 20 is applied with ultrasonic welding so as to increase the strength of the wire bin 90 and improve the aesthetic is fixed with a handle 92 by ultrasonic welding.

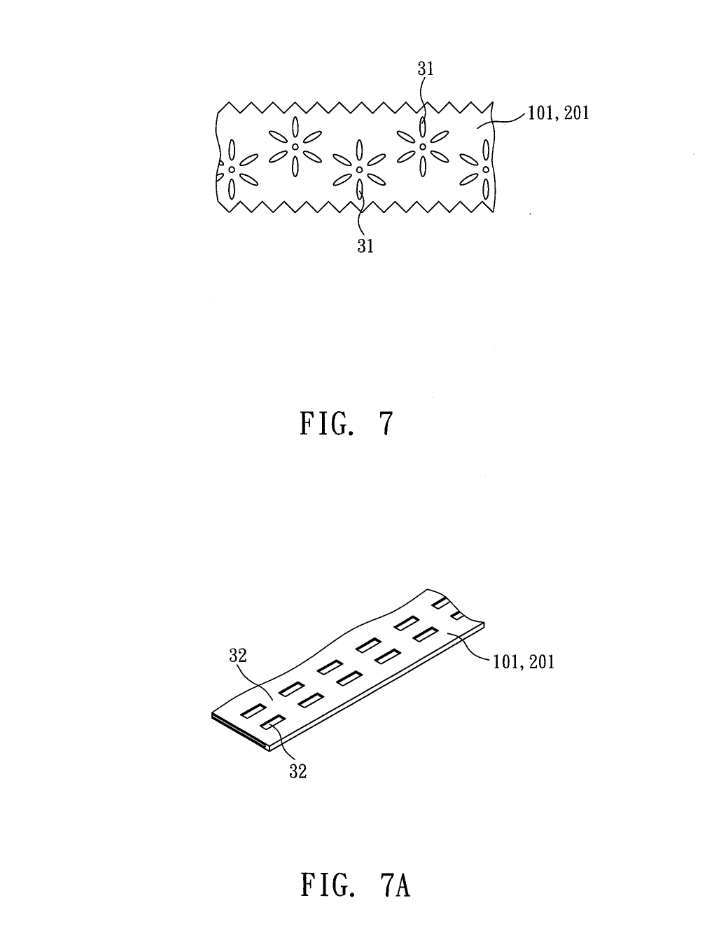

Refer to FIG. 7, the weld zones 101, 201 are further processed by lace sewing such as seaming, cutting, stripping, pressing, printing, splitting, hole punching, pattern, forming, printing, hot stamping, pleating, reinforcement, and so on. For example, use an ultrasonic lace sewing to press the weld zones 101, 201 so as to form patterns, laces or textures 31 on surface of the weld zones 101, 201 for increasing the aesthetic value and decorative functions of the device. Moreover, the weld zones 101, 201 can be designed into hollow patterns 31 so as to improve the sense of design and aesthetic value.

Refer to FIG. 7A, through the process of ultrasonic welding, dotted lines 32 like running stitches are formed on surfaces of the weld zones 101, 201 so as to increase the sense of design and aesthetic value.

Compared with the structure available now, the present invention has following advantages:

1. The organization devices of the present invention don't need binding. Thus the manufacturing efficiency is improved and the cost is down.
2. The organization devices of the present invention are produced by ultrasonic welding without stitches and thread ends. Thus the present invention has higher aesthetic value and decorative effect, compared with conventional devices produced by stitching. Moreover, the present invention has higher flatness that helps folding and packaging.
3. The weld zones of the organization devices according to the present invention provide support and hold the shape. Thus the decorative device is not deformed or distorted easily in use due to the softness of the cloth. The life span of the decorative devices is also extended.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A manufacturing method of organization devices comprising the steps of:
providing at least one first piece of cloth that is cut into required shape and size according to a design of an organization device; the first piece of cloth is disposed with at least one weld zone for being joined with other weld zones by ultrasonic welding;
providing at least one second piece of cloth that is made from the same material as that of the first cloth and is cut into required shape and size according to the design of the organization device; the second piece of cloth is disposed with at least one weld zone that is corresponding to the weld zone of the first piece of cloth and is used for being joined with other weld zones by ultrasonic welding; and
using ultrasonic welding to connect the weld zone of the first piece of cloth with the weld zone of the second piece of cloth and produce at least one receiving space between the at least one first piece of cloth and the at least one second piece of cloth so as to form the organization device.

2. An organization device comprising:
at least one first piece of cloth that is cut into desired shape and size and having at least one weld zone for being joined with other weld zone by ultrasonic welding;
at least one second piece of cloth that is made from the same material as that of the first piece of cloth and is cut into desired shape and size; the second piece of cloth having at least one weld zone that is corresponding to the weld zone of the first piece of cloth and used for being joined with the at least one weld zone of the first piece of cloth;
wherein the weld zone of the first piece of cloth and the weld zone of the second piece of cloth are joined by ultrasonic welding so as to connect the first piece of cloth and the second piece of cloth; at least one receiving space is formed between the at least one first piece of cloth and the at least one second piece of cloth.

3. The device as claimed in claim 2, wherein the weld zone of the first piece of cloth and the weld zone of the second piece of cloth are arranged at preset positions intended to be joined by ultrasonic welding between the first piece of cloth and the second piece of cloth.

4. The device as claimed in claim 2, wherein the weld zone of the first piece of cloth is disposed on at least one position of a periphery or a folded area of the first piece of cloth.

5. The device as claimed in claim 2, wherein the weld zone of the second piece of cloth is disposed on at least one position of a periphery or a folded area of the second piece of cloth.

6. The device as claimed from claim 2, wherein the weld zones treated and joined by ultrasonic welding are flat and dotted lines like running stitches are formed on surfaces of the weld zones.

7. The device as claimed from claim 3, wherein the weld zones treated and joined by ultrasonic welding are flat and dotted lines like running stitches are formed on surfaces of the weld zones.

8. The device as claimed from claim 2, wherein the weld zone is further disposed with at least one pattern.

9. The device as claimed from claim 3, wherein the weld zone is further disposed with at least one pattern.

10. The device as claimed in claim 2, wherein the first piece of cloth further covers at least one support member.

11. The device as claimed in claim 10, wherein the support member is a support plate.

12. The device as claimed in claim 2, wherein the second piece of cloth further covers at least one support member.

13. The device as claimed in claim 12, wherein the support member is a support plate.

14. The device as claimed in claim 12, wherein the support member is a metal wire frame.

15. The device as claimed in claim 2, wherein the organization device is a garment bag, a hanging bag with multiple pockets, a closet with multiple compartments, an organizer box, a clothes press, an underbed storage unit, an eye level cabinet, a wire bin or a shoe cabinet with multiple compartments.
